(19) United States
(12) Patent Application Publication
(10) Pub. No.: US 2011/0266774 A1
(43) Pub. Date: Nov. 3, 2011

(54) SELF-STEERING DOLLY FOR LONG LOAD HEAVY HAUL

(76) Inventor: John Stewart GREGG, Summerland (CA)

(21) Appl. No.: 12/772,279

(22) Filed: May 3, 2010

(51) Int. Cl. B62D 13/00; F16C 19/14

(52) U.S. Cl. 280/419; 384/618

(57) ABSTRACT

A dolly for the transport of elongated loads which includes an adjustable steer linkage assembly, an adjustable steer ratio, means for switching between rear- and forward-steering, and manual over-ride of the self-steering configuration. All of these adjustments can be achieved without the need to manually delink subassemblies.

### BACKGROUND TO THE INVENTION

1. Field of the Invention

The present invention relates generally transport dollies, and in particular, to multi-axle self-steering dollies for transport of elongated loads.

2. Description of the Prior Art

Self-steering dollies are used by the heavy haul industry for transporting elongated loads. These loads are supported by the towing vehicle at the leading end and by the self-steering dolly at the trailing end. The dolly itself is often towed only by connection to the towing vehicle through the load itself and not by any direct connection. The dolly may be described as a full trailer type chassis having a group of axles at each end of the chassis and a turntable mounted midship for load carriage. The turntable allows the load to change its orientation with respect to the dolly without applying a turning force to the dolly. This permits the load to swing in an arc when the tractor pulling the vehicle combination deviates from a straight line and commences to turn around a curve.

Generally, axles at one end of the dolly chassis are steerable while the axles at the other end are not. The self-steering function is typically achieved with a linkage connection between the steerable axles and the midship load bolster turntable which is aligned with the elongated load.

The ideal situation is for the dolly to track a path of the towing vehicle when the towing vehicle starts to proceed around a curve. On one hand, if the dolly has no steering capability, it would continue to proceed in a straight direction. On the other hand, if the dolly were coupled as a trailer to the towing vehicle, then it would be pulled in alignment with the towing vehicle. In which case, if the wheels of the dolly were not able to turn, the dolly would be forced to skid into alignment with the towing vehicle.

For the dolly to successfully track the path of the towing vehicle, a steering capability must be present in the dolly which will incline the steering wheels in the dolly in the direction of the turn, but at an angular inclination which is less than that of the towing vehicle. The direction of the steering of the steering wheels is typically automatically established by a series of mechanical linkages that extend between the turntable and the steering assembly.

The self-steering linkage ratio is designed so that the dolly will steer in a path closely approximating that of the towing vehicle. This feature reduces or negates the trait of “off tracking” normally associated with long vehicle combinations lacking self-steering features. Without this reduced off-tracking control, such long combinations would not be able to negotiate many typical road bends or corners.

The linkage ratio associated with the linkage connection between the steerable axles and the midship load bolster turntable may be fixed or adjustable as the manufacturer and customer dictates. When fixed, a ratio is selected that gives acceptable tracking performance over a typical range of lengths that will be used. As the load length varies from the ideal design length, the tracking performance will gradually deviate from the intended performance. The majority of the newer dollies are being produced with adjustable steering ratios to better accommodate the variation of load length while achieving optimal tracking performance. U.S. Pat. No. 3,993,326 discloses how to provide a proportional ratio between the deflection of the steering wheels and the deflection of the load.

Most of the existing adjustable ratio steering systems use a “Stinger and Compensator” system with an adjustable length stinger arm. The “Stinger” is an arm that extends from the turntable along the fore/aft axis of the turntable and is adjustable in length by telescoping through a pocket in the turntable. This adjustment is usually made by a hydraulic cylinder. Once the stinger length is set, it is locked or clamped in place. The “Compensator” is a telescopic arm that is linked to the steering axles and extends from a pocket that is either mounted to a steerable axle turntable or pivotally mounted to the dolly chassis with linkages extending to the steerable axle. The outer end of the Compensator is connected to the outer end of the Stinger through a coupling that allows rotation between these two members.

The Compensator is also free to telescope as the turntable rotates, but on a continuous basis throughout operation. This freedom to telescope is required as the arc path of the coupling between the Compensator and the Stinger moves away from the Compensator pivot during turning, requiring the Compensator to extend further. The steering ratio is determined by the relative lengths of the Stinger and Compensator. Lengthening the Stinger or shortening the Compensator thus increases the steering ratio and vice versa.

These dollies may also be steered manually when required for difficult manoeuvres or backing-up. This is accomplished with one or more hydraulic cylinders that are connected to the steering linkages and driven by an on-board hydraulic power unit controlled by radio-controlled valving. However, for manual steering, the self-steering linkage must be disconnected. Conversely, when self-steering is active, the manual steering cylinders are disconnected.

It is time consuming to disconnect and re-connect linkage components to convert between the self-steering or manual over-ride modes. For this reason, some dollies are available with a self-steering system that uses a combination of hydraulic master cylinders connected to the load turntable and slave cylinders to steer the axles in place of a direct mechanical linkage. These cylinders control steering during either self-steering or manual over-ride, replacing the link from the compensator to the axle. With this system, switching from self-steer to manual mode is simply accomplished with the hydraulic valving.

Another limitation of the Stinger/Compensator system is that reversing steering direction cannot be easily done. This is usually accomplished with hydraulic valving that diverts the fluid from the right driving slave cylinder to the left driving slave cylinder and vice versa. In this approach, the hydraulic master/slave system requires four steering cylinders in total, and communicating hoses linking the cylinders during operation of the self-steering mode.

With regards to steering axle, three common configurations are used. The first consists of a single large turntable between the dolly chassis and a subframe that has three straight axles and their suspension mounted to it. This option involves very high steering forces as the front and rear axles on the subframe must skid laterally as they steer, requiring very strong, and thus heavy, steering linkage. This configuration also requires the dolly frame to be high enough for the wheels to pass under it as they steer.

The second type uses three smaller turntables, each with a single straight axle and suspension mounted and interconnecting steering links. This design eliminates skid steer so the steering links can be of lighter construction. Also the dolly frame can be lower as the wheels do not have to pass fully under it as long as the frame is narrow enough. This is a benefit for overhanging load clearance.

A third type uses steering axles having spindles steerable on kingpins at the axle beam ends, mounted via a suspension directly to the dolly frame, thus eliminating the steering turntables and subframes. This design allows the lowest and widest frame of the three as there is less intrusion of the wheels for a given steering angle. Although the steering axles are heavier and more costly than the straight axles of the other two types, the elimination of the steering turntables and subframes offset these factors. The steering forces of this design are lowest of the three commonly-used systems.

These dollies are also often used as the rear axle group in long trailer chassis to obtain the above described tracking benefit.

There is thus a need to provide a design that is relatively less complex and provides for a modularized mechanical system composed of easily manageable sub-assemblies. The system should allow for relative ease of adjustment of the steer ratio and steer linkage length for given elongated load characteristics. In addition, the system should allow for easy adaptation between front-wheel and rear-wheel steering, while also allowing for manual override of self-steering in a safe manner. These desirable traits should be achieved without the need for decoupling elements of the steer linkage system.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

In one aspect of the present invention, there is provided a dolly for transport of an elongated load, the dolly comprising: a chassis; one or more steering axles; a load-bearing turntable mounted on the chassis; a steering linkage for communication of rotation of the turntable to the one or more steering axles, the steering linkage comprises: a steering ratio adjustment means; a steering linkage length adjustment means; a means to adjust between front-wheel and rear-wheel steering; and a means to adjust between self-steering and manual steering of the dolly, wherein the steering linkage further comprises: an anchor point in communication with the turntable, the anchor point anchoring a length-adjustable first member in communication with the one or more steering axles on one side of a longitudinal axis of the dolly; and the anchor point adjustable in position relative to a central axis of the turntable.

the load-bearing member of the dolly may use a central hub with tapered roller bearings to withstand the radial horizontal loads and a peripheral roller thrust bearing to withstand the axial vertical loads.

The tapered roller bearings may be permanently lubricated and sealed from the elements. Any wear of these bearings may be compensated for by re-adjusting the spindle nut as is commonly done on free rolling wheel bearings.

The peripheral roller thrust bearing may consist of a radially oriented array of roller bearings that may run between flat plates being the base plate of the turntable and the top plate of the dolly chassis. As the bearing area of these rollers is many times greater than the balls of a slewing ring, the bearing stress is low, and thus these rollers may operate without periodic or dynamic lubrication. As the rollers wear, radial clearance is not affected, so steering precision does not deteriorate.

The steering linkage preferably uses a direct acting drag link that is hydraulically adjustable in length to communicate the load turntable rotation to the steering axles. This drag link preferably comprises a hydraulic cylinder with integral pilot operated check or lock valves, and through its operation, straight line steering trim may be adjusted, and manual steering over-ride provided.

Furthermore, straight line alignment of steering trim may be accomplished at any time on-the-fly by extending or retracting the hydraulic cylinder. While this feature is also available on other systems that use master/slave cylinders, other extant mechanical linkage systems require manual adjustment that can be quite time consuming. This new configuration differs structurally in that the hydraulic linkage actuator may be finely adjusted in place, allowing for the reconfiguration of steering linkage characteristics under hydraulic control.

A manual steering over-ride facility may also be effected by hydraulic means, preferably one hydraulic cylinder, without requiring its disconnection from the rest of the steering linkage.

The steering linkage further comprises: an anchor point in communication with the turntable which, anchors a length-adjustable first member in communication with one or more of the steering axles on one side of a longitudinal axis of the dolly. The anchor point can be adjusted relative to the central axis of the turntable.

The steering ratio adjustment of the linkage may be accomplished by adjusting the position of the anchor point, as follows. The anchor point is preferably located at the free end of a swing arm that is pivotally mounted to the turntable and is able to swing from side to side to various positions on either side of the longitudinal axis of the dolly. Steering ratio adjustment may then be set by moving and locking this swing arm in its desired position with a linear actuator. The linear actuator is preferably a screw type, more preferably, an acme screw. The further the anchor point is from the turntable central axis, the greater the steering ratio. The linear actuator may be manually adjusted or in a preferred embodiment powered by a motor.

The steering direction is determined by placement of the anchor point as follows. The connection point between the hydraulic cylinder and the steering axle is located on one side of the longitudinal axis of the dolly. Forward-wheel steering is obtained by placing the anchor point on the opposite side of the longitudinal axis, while rear-wheel steering is obtained by placing the anchor point on the same side of the longitudinal axis.

In addition, the present invention can be used with all three types of steering axle configurations described above. It is preferably used in conjunction with the third type of steering axle configuration (spindle-type).

One advantage of the present invention over the prior art is decreased overall complexity, significant material reduction, and a modularized mechanical system composed of more easily manageable sub-assemblies. The steering system of the present invention also uses fewer hydraulic cylinders and simpler hydraulic circuitry than prior art systems. This configuration provides a significant ancillary safety enhancement, in that in the event of a hydraulic hose rupture, self-steering control is not lost.

Yet another advantage of the present system over the prior art is the ability to reverse steering direction so that the dolly can be reconfigured for use with the steering axles at the front or rear, depending on the target load configuration and clearance.

Yet another advantage of the present invention is that the design lends itself to modularization into discrete and manageable sub-assemblies of reduced complexity that are well suited to manufacture and maintenance.

The foregoing summarizes the principal features of the invention and some of its optional aspects. The invention may be further understood by the description of the preferred embodiments, in conjunction with the drawings, which now follow.

Wherever ranges of values are referenced within this specification, sub-ranges therein are intended to be included within the scope of the invention unless otherwise indicated. Where characteristics are attributed to one or another variant of the invention, unless otherwise indicated, such characteristics are intended to apply to all other variants of the invention where such characteristics are appropriate or compatible with such other variants.

### BRIEF DESCRIPTION OF THE DRAWINGS

FIG. 1 illustrates a top perspective view of an embodiment of the present invention configured for forward-steering.

FIG. 2 illustrates an underside view of the embodiment shown in FIG. 1.

FIG. 3 illustrates a side perspective view of the embodiment shown in FIG. 1.

FIG. 4 illustrates an underside detailed view of the embodiment shown in FIG. 2, showing a steering linkage of the present invention, in the forward-steering configuration.

FIG. 5 illustrates an underside detailed view of the embodiment shown in FIG. 4, showing a steering linkage of the present invention.

FIG. 6 illustrates an underside detailed view of the embodiment of the invention, showing a steering linkage configured for rear-wheel steering

FIG. 7 illustrates an underside detailed view of the embodiment shown in FIG. 6.

FIG. 8 illustrates a detailed view of a bearing assembly of an embodiment of the present invention.

FIG. 9 illustrates a detailed view of a bearing assembly of an embodiment of the present invention with the turntable removed for visibility.

FIG. 10 illustrates a top perspective view of an embodiment of the present invention configured for rear-steering.

FIG. 11 illustrates an underside view of the embodiment shown in FIG. 1.

FIG. 12 illustrates a side perspective view of the embodiment shown in FIG. 1.

### DESCRIPTION OF THE PREFERRED EMBODIMENT

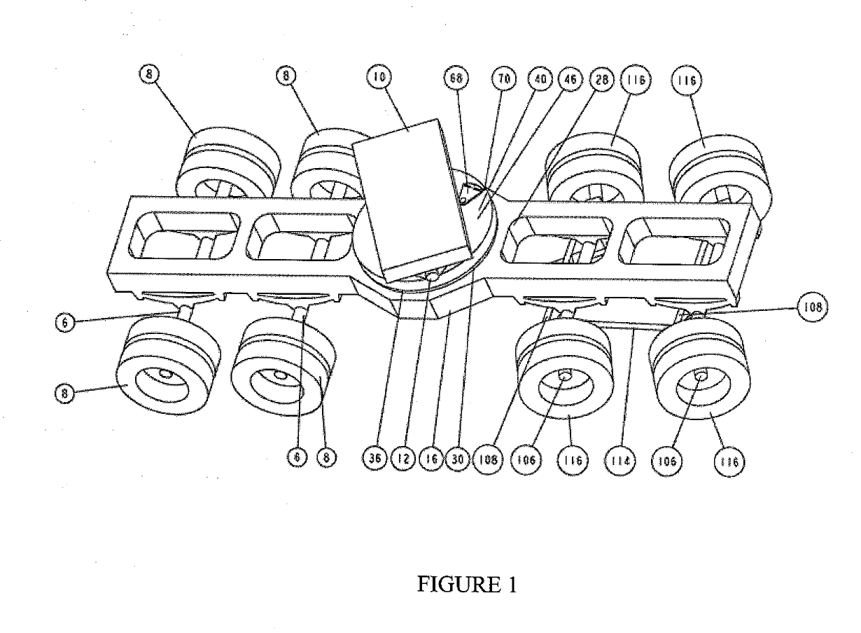

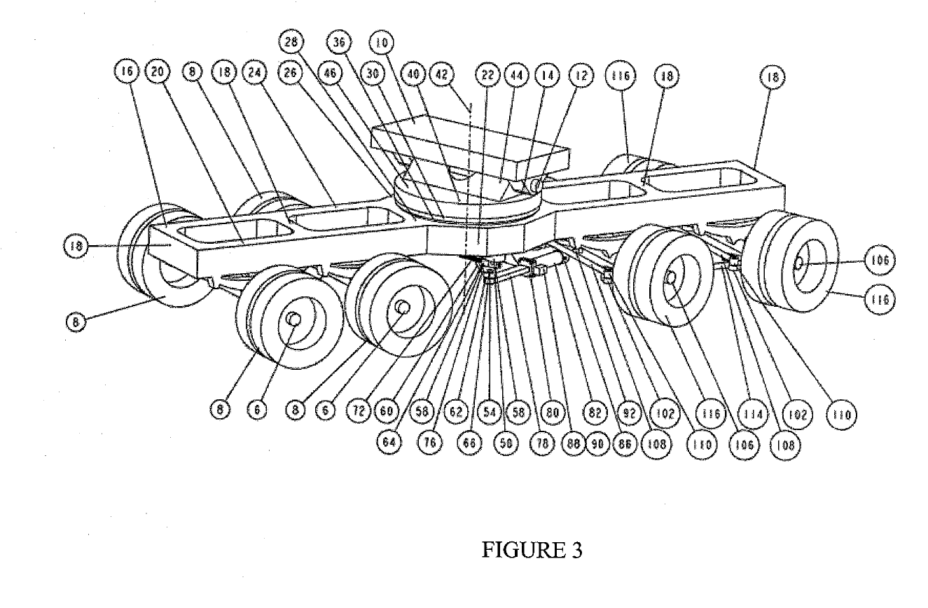

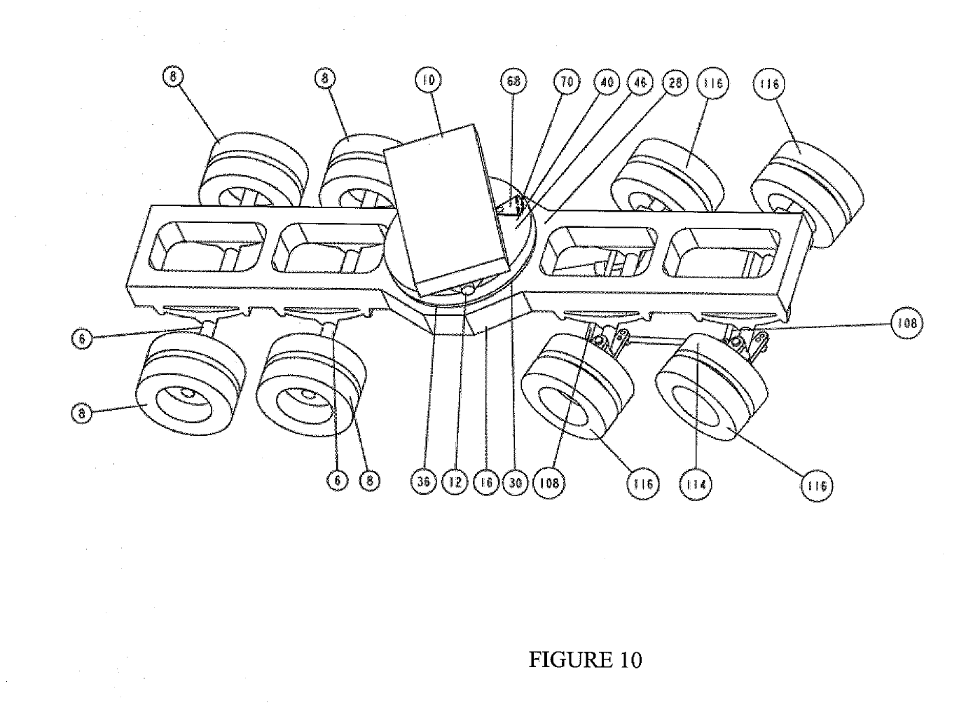

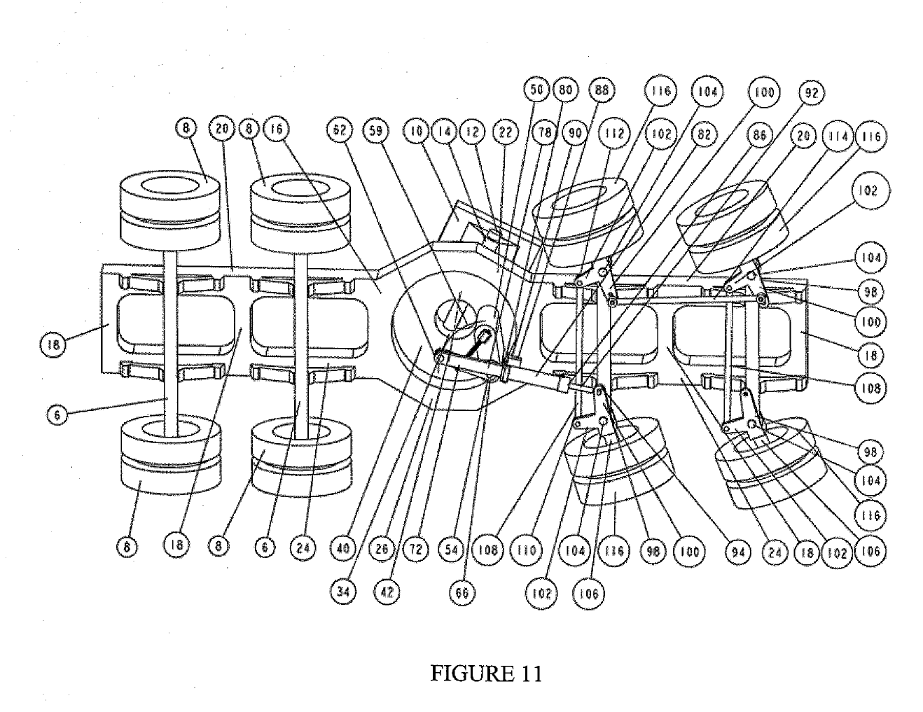

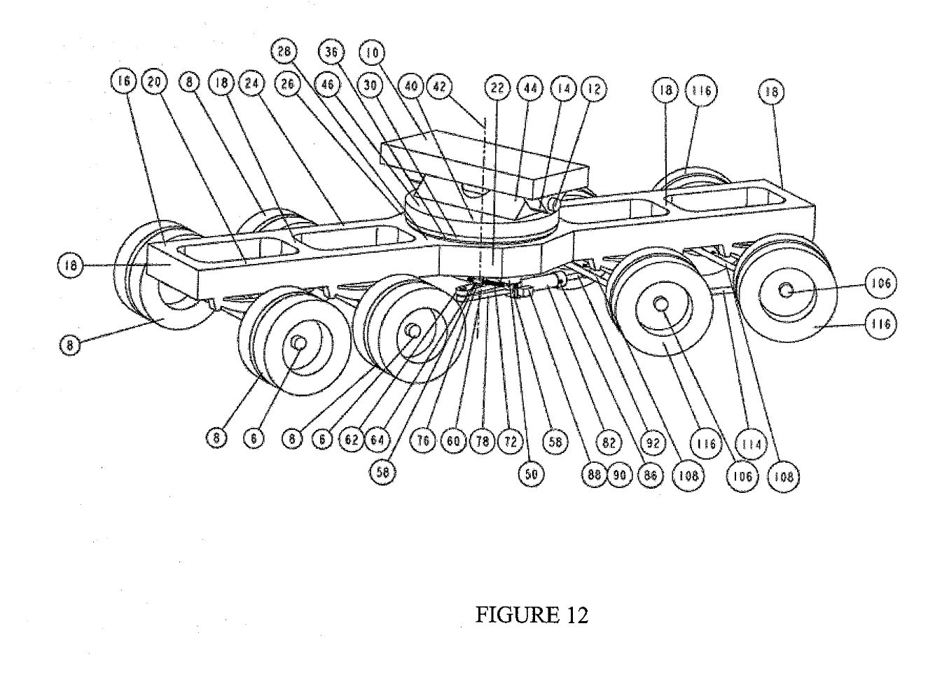

As shown in FIGS. 1-4 and 10-12, the self-steering dolly of the present invention may be provided with a low profile chassis frame 16 comprising a left side chassis rail 20 and a right side chassis rail 24. Chassis rails 20 and 24 are structurally connected together by a series of cross members 18, and a series of straight axles 6 with road wheels 8 are mounted transversely beneath the rails.

Generally midway along its length, left chassis rail 20 is formed to provide a left side turntable supporting feature 22, and right chassis rail 24 is formed to provide a corresponding right side turntable supporting feature 26. The turntable supporting features 22 and 26 are securely connected together by bearing support plate 28, which is itself fitted underneath with turntable cage wall 30 and buttressed by roller bearing cage (32). Inside cage wall 30 are mounted tapered roller bearings 37, which serve to withstand radial loading.

In self-steering operation, the forces arising due to changing load angles with respect to the longitudinal axis of chassis 16 act to rotate load bearing bunk 10, and this rotation is transmitted to turntable body 40, which turns upon bearing sets 37 and 38. Bearings 37 withstand radial components of the load-derived force on the turntable, while radially arrayed thrust bearings 38 take up the axial components.

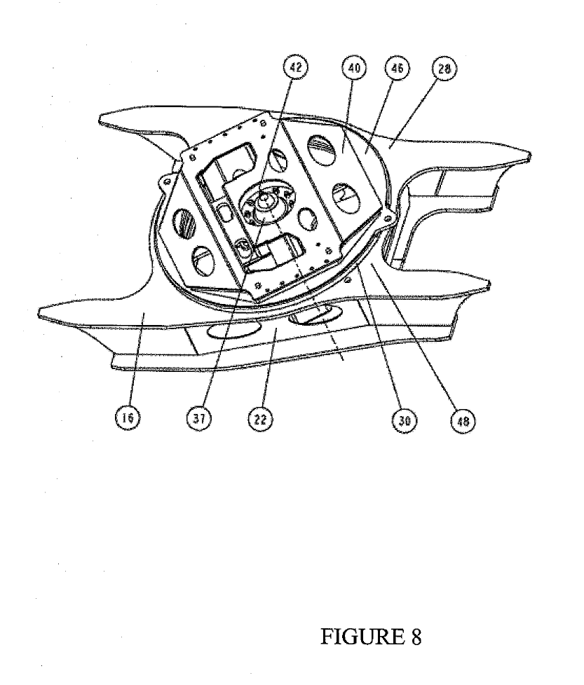

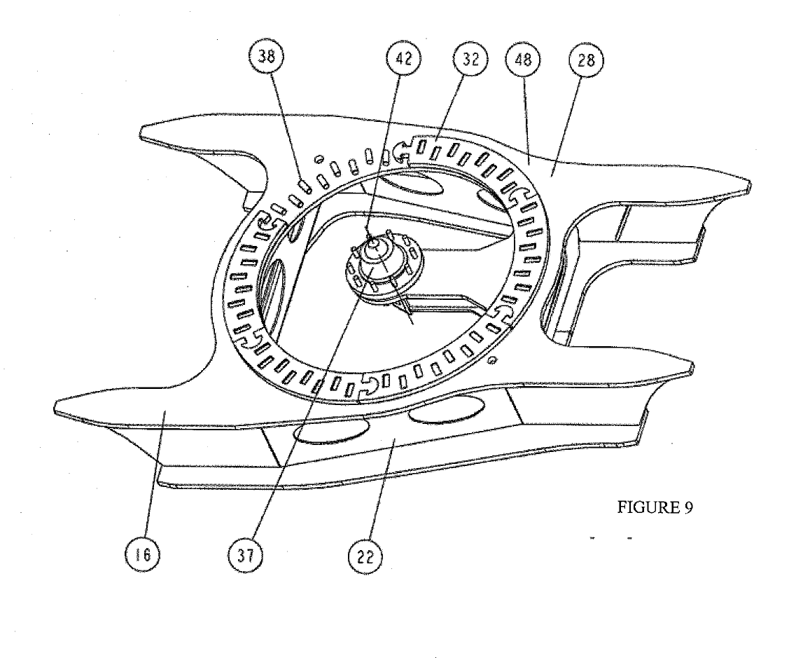

As shown in FIGS. 8 and 9, in the centre of bearing support plate 28 is provided a generally circular turntable clearance aperture 34, and on top of the plate above the aperture is mounted an annular roller thrust bearing assembly 36. Roller bearing assembly 36 is provided with a series of radially arrayed thrust roller bearings 38, which serve to withstand axial loading. Bearings 38 are contained by a UHMW-PE polyethylene cage, oriented along a substantially radial line projecting from the putative centre of the bearing assembly. As the bearing area of these rollers is collectively very large, individual bearing stress is low, and thus these rollers may be run dry.

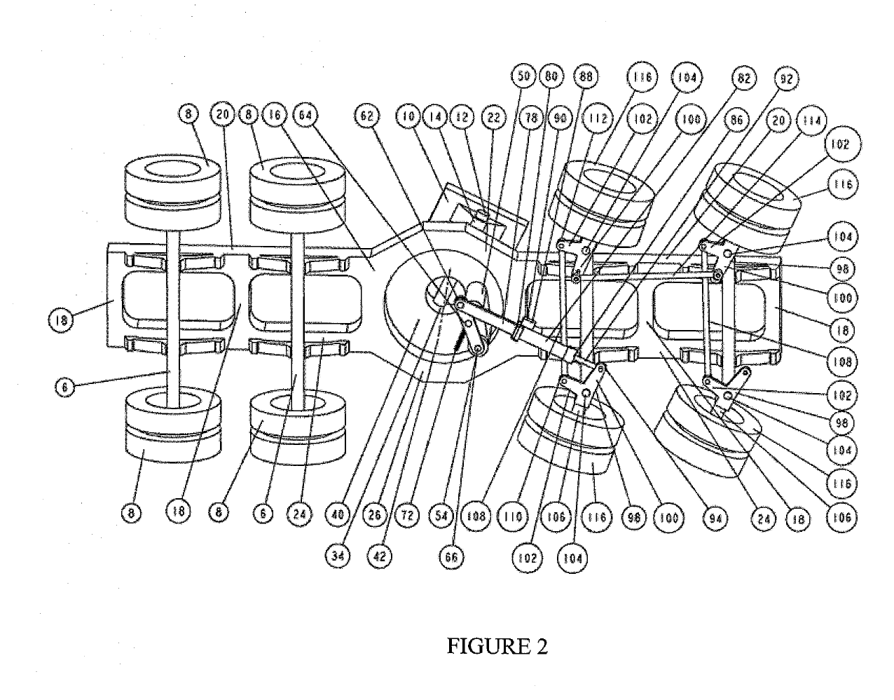

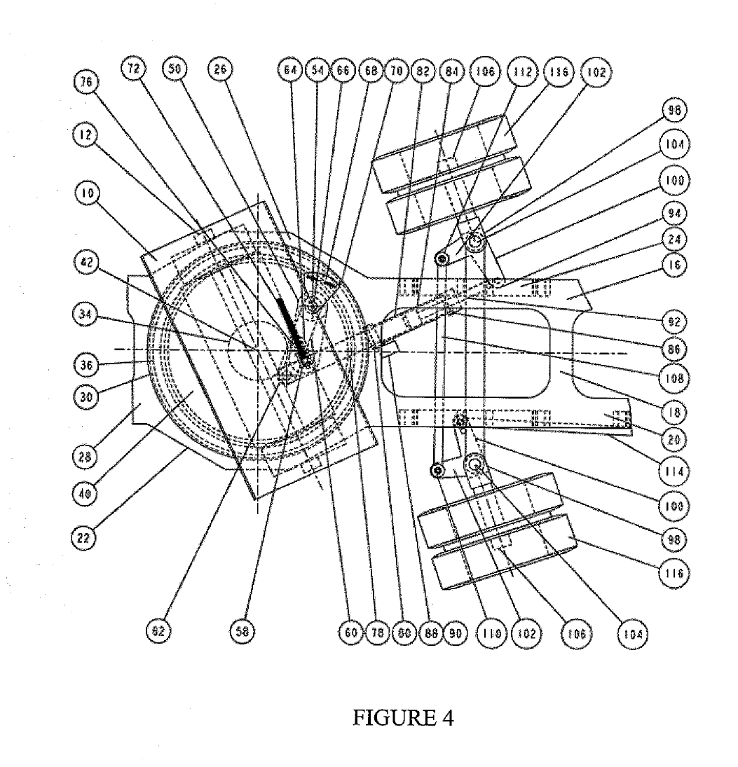

Turntable body 40 is formed about a central vertical axis 42 with a larger radius, upper bearing upper support deck 46, having on its lower horizontal surface a bearing contact surface 48, which has a radius sized to sit atop roller bearing assembly 36 as shown in FIG. 4. Turntable body 40 may thus rotate on bearings 38 independently of the orientation of the chassis frame 16. In FIGS. 2-4, it is seen that on the top of the turntable upper deck 46 is formed a bunk shaft pillow block feature 44, within which are fitted bunk mounting journal bearings 14. Load-bearing bunk 10 is provided on its underside with bunk mounting shaft 12, which in running through journal bearings 14 allows the bunk to independently tilt with respect to the horizontal plane of turntable body 40.

In FIGS. 2,4, 6 and 11 can be seen projecting below the upper support deck 46 of turntable body 40, a turntable steering linkage attachment structure 50, which provides on its lower surface external and internal radius attachment points (not shown).

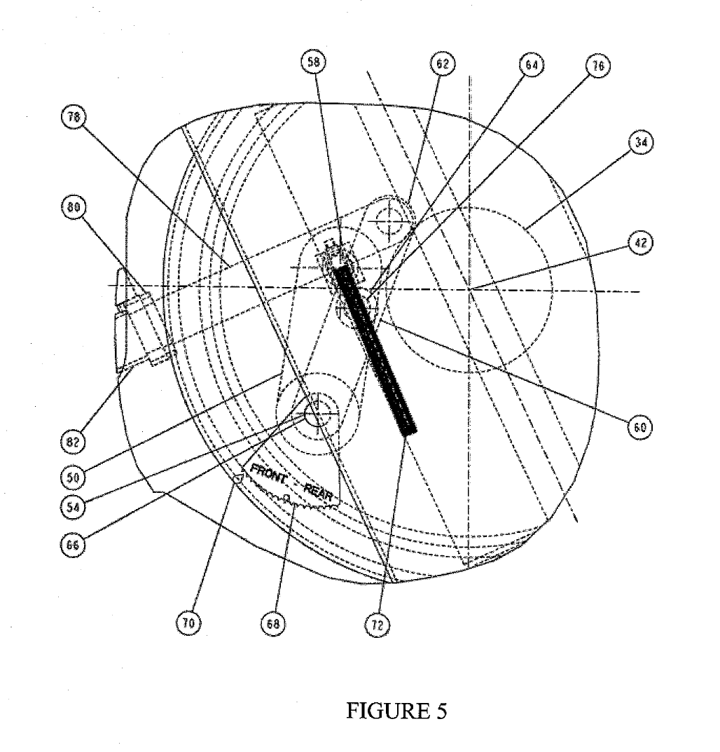

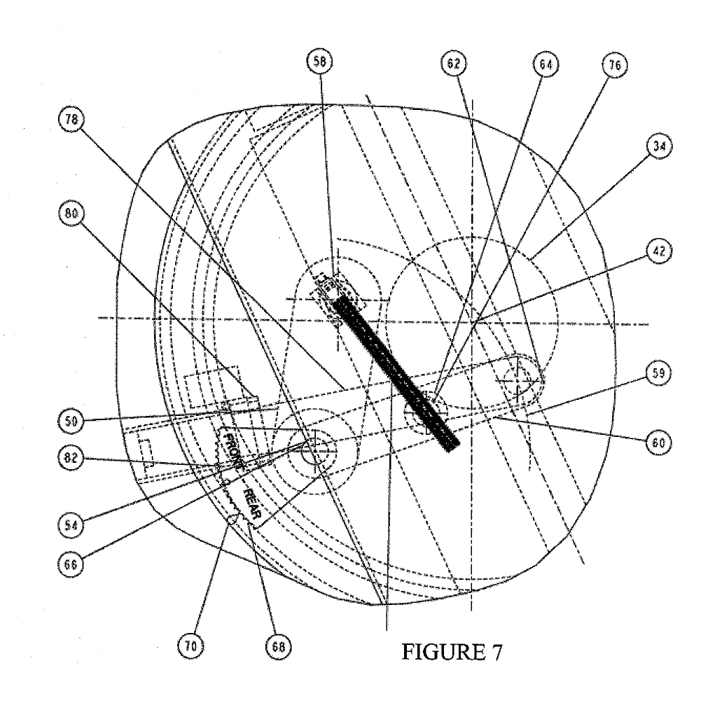

Turning to FIGS. 5 and 7, radius adjustment swing arm 60 is mounted on swing arm swivel 54 via shaft 66 such that the centre of arm link connecting boss 62 at the free end of the arm may assume any position along an arc 59 (shown in FIGS. 7, 10 and 12) passing generally through the central axis 42 of turntable body 40.

Shown in the detail of FIGS. 5 and 7, is a rotatable ACME screw housing attachment 58, which may contain a motor and driving mechanism to turn ACME screw 72. Screw 72 is arranged to extend outwards from housing 58, such that its longitudinal axis may transect swing arm 60 at the arm's ACME nut connecting boss 64. ACME nut 76 is threaded onto screw 72 and rotatably mounted on boss 64, where the screw may then serve as an adjustable positioning actuator and retainer for swing arm 60.

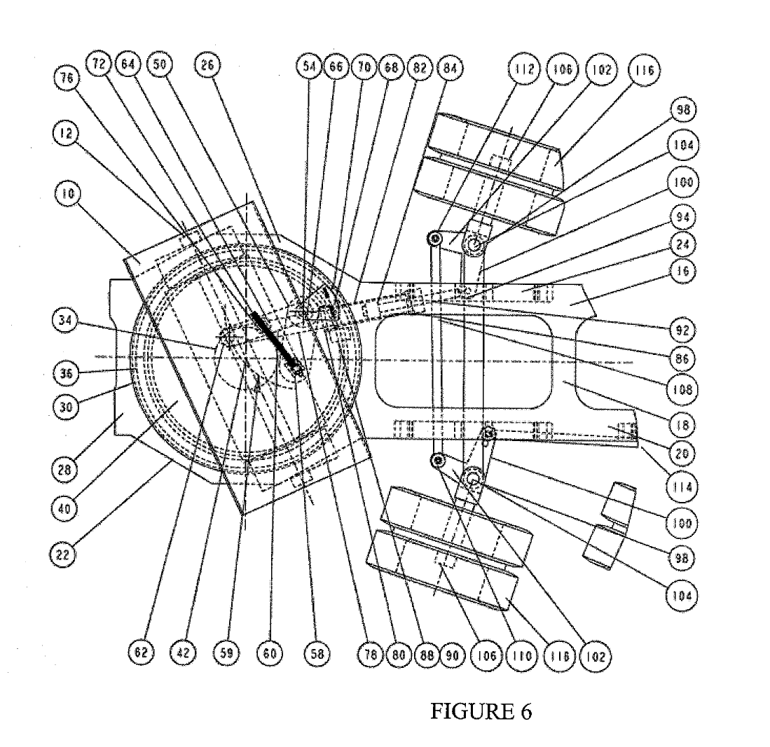

Depicted in FIGS. 4 and 6, is the adjustable drag linkage assembly. The turntable-proximate end of drag link 78 is rotatably attached to swing arm 60 at link connection boss 62, and the link's distal end is fastened to the head end of hydraulic cylinder barrel 82 at cylinder attachment plate 80. Piston 84 is situated within the bore of cylinder barrel 82, attached to piston rod 92, and the rod extends outward from the hydraulic actuator through rod end head 86. Pilot operated check valves 88 and 90 are attached to the head and rod end ports of barrel 82 respectively, in order to provide the steering drag linkage with a double-acting and lockable hydraulic actuator and allow the length of the drag link assembly to be adjusted, as described below.

In the absence of pilot signal to either valve 88 and 90, the piston rod 92 is normally locked in position, and the length of the drag link assembly remains fixed. Applying increased hydraulic pressure to the inlet port of valve 88 with the pilot signal present at valve 90 will cause piston rod 92 to extend outward from rod end head 86, increasing the overall length of the drag link assembly. Conversely, applying increased pressure to the inlet port of valve 90 with a pilot signal to valve 88 causes the rod to retract, shortening the length of the drag link assembly. When both valves 88 and 90 are simultaneously provided with pilot signal, piston rod 92 is free to move within cylinder barrel 82 in response to longitudinal forces acting upon it.

As shown in FIGS. 2, 4, 6 and 11, at the free end of piston rod 92 is formed steering arm attachment boss 94, through which steering link retaining pin 96 connects rod 90 to steering atm 100 of knuckle 98. Each knuckle 98 is rotatably attached to chassis frame 16 via kingpin 104, allowing rotation about a substantially vertical pivoting axis. Laterally opposite knuckles are connected by cross tie rods 108 attached at each end to the knuckle lateral tie rod attach arm at first and second tie rod ends 110 and 112, respectively, such that left and right side knuckles will move together and assume the same steering angle with respect to the chassis. Projecting outwards from each steering knuckle 98 is a stub axle 106, on which the steerable wheel sets are rotatably attached. The knuckle steering arms 100 of consecutive steerable tandem axles are connected together by inter-axle coupling rods 114 in order that all ranks of steerable road wheels 116 reproduce the same directional angle.

As turntable body 40 rotates within central turntable aperture 34, its downward projecting linkage attachment structure 50 traces a circular arc around central axis 42, which causes the free end of the radius adjustment swing arm 60 to itself describe a circular arc, the radius of which may be adjusted by operating ACME screw 72 and changing the distance between the screw housing 74 and nut 76. The swing arm 60 thus operates as a crank, and the fore-aft excursive component of the swing arm's arc is coupled by the drag link assembly of link 78, hydraulic cylinder 82, and piston rod 92 to act upon steering arm 100, turning steering knuckle 98 on kingpin 104 to set road wheel angle. Cross tie rods 108 and inter-axle coupling rods 114 then propagate the first road wheel angle to the other steering knuckles and steerable road wheels 116.

In order to adjust the steering ratio and set the response characteristics of the steerable wheels to changes in load attitude, the drag link hydraulic actuator system is unlocked by providing pilot signals to check valves 88 and 90. With the drag linkage freed, operating the ACME screw actuator to increase the distance between the turntable's axis of rotation 42 and the free end of radius adjustment arm 60 increases the radius of the arm's arc of travel, thus leading to a greater fore-and-aft excursion of the drag link assembly during turntable rotation, and a greater resulting steering ratio at the road wheels. Conversely, operating the ACME screw actuator to decrease the radius of travel of arm 60 with respect to the turntable's axis of rotation leads to a smaller drag link excursion during turntable rotation and a lesser steering ratio. Such adjustment allows the steering ratio to be precisely and accurately optimized for loads of differing length. Removing pilot signals from valves 88 and 90 returns the drag linkage to its normal rigid and locked state.

As shown in FIGS. 4 and 5, to configure the dolly's steering linkage for front-wheel steering, the drag link assembly is unlocked, and the ACME screw actuator is operated to bring the free end of radius adjustment swing arm 60 beneath the opposite side of turntable body 40 from the drag link connected steering knuckle 98. This configuration ensures that an increased turntable rotation in a given direction leads to a corresponding change in road wheel steering angle in the same direction. The drag linkage may then be returned to its normal locked state for self-steering operation.

In FIGS. 6 and 7, rear wheel is achieved by releasing the drag linkage and operating the ACME screw actuator to swing the free end of radius adjustment arm 60 to a position beneath the turntable 40 on the same side as that of drag link connected steering knuckle. In this case, when the drag linkage is returned to its normal locked state, an increased turntable rotation in a given direction leads to a corresponding change in road wheel steering angle in the opposite direction.

A pointer (68) is affixed at shaft (66) with markings “Rear” and “Front”, and configured for appropriate alignment with the marker (70) on the underside of the turntable.

Straight line steering trim may be adjusted on the fly by operating the hydraulic actuator to effect small adjustments to the overall length of the drag linkage, and with larger drag link actuator manipulations, manually controlled steering can likewise be performed.

### CONCLUSION

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive property or privilege is claimed are defined as follows:

1. A dolly for transport of an elongated load, said dolly comprising:
a chassis;
one or more steering axles
a load-bearing turntable mounted on said chassis;
a steering linkage for communication of rotation of said turntable to said one or more steering axles,
said steering linkage comprising:
a steering ratio adjustment means;
a steering linkage length adjustment means;
a means to adjust between front-wheel and rear-wheel steering; and
a means to adjust between self-steering and manual steering of said dolly;
wherein said steering linkage further comprises: an anchor point in communication with said turntable, said anchor point anchoring a length-adjustable first member in communication with said one or more steering axles on one side of a longitudinal axis of said dolly; and said anchor point adjustable in position relative to a central axis of said turntable.

2. The dolly of claim 1, wherein said length-adjustable first member is a hydraulic cylinder.

3. The dolly of claim 1, wherein said length-adjustable first member is pilot-operated for over-ride of self-steering.

4. The dolly of claim 1, wherein said steering ratio is determined by a distance between said anchor point and said central axis.

5. The dolly of claim 1, wherein said anchor point is a connection point between said length-adjustable first member and a second member mounted pivotally to said turntable, and said second member is locked in position by a linear actuator.

6. The dolly of claim 5, wherein said second member is a swing arm and said linear actuator is a screw type.

7. The dolly of claim 1, wherein a motor is used to adjust said anchor point.

8. The dolly of claim 1, wherein forward-wheel steering is obtained by placing said anchor point on an opposite side of said longitudinal axis; and rear-wheel steering is obtained by placing said anchor point on said one side of said longitudinal axis.

9. The dolly of claim 1, wherein said load-bearing turntable is mounted on an assembly comprising bearings to withstand a radial and an axial load.

10. The dolly of claim 9, wherein a tapered roller bearing assembly is used to withstand said radial load.

11. The dolly of claim 9, wherein a peripheral roller thrust bearing assembly is used to withstand said axial load.

12. The dolly of claim 11, wherein said roller thrust bearing assembly comprises a radially-oriented array of roller bearings.

13. A device for withstanding a radial and an axial load on a load-bearing turntable, said device comprising: a tapered roller bearing assembly for withstanding said radial load; and a peripheral roller thrust bearing assembly for withstanding said axial load.

14. The device of claim 13, wherein said roller thrust bearing assembly comprises a radially-oriented array of roller bearings.
